(19) United States
(12) Patent Application Publication
(10) Pub. No.: US 2025/0298720 A1
(43) Pub. Date: Sep. 25, 2025

(54) INTELLIGENT CODE INTERCEPTOR FOR GENERATING A NO-CODE AUTOMATION TEST SUITE USING GENERATIVE ARTIFICIAL INTELLIGENCE (AI)

(71) Applicant: Bank of America Corporation, Charlotte, NC (US)

(72) Inventors: Divya Sharma, Delhi (IN); Sandeep Verma, Haryana (IN)

(21) Appl. No.: 18/612,236

(22) Filed: Mar. 21, 2024

(51) Int. Cl. G06F 11/36

(52) U.S. Cl. CPC G06F 11/3604

(57) ABSTRACT

A computing platform may receive test input information comprising input information to validate code for an application. The computing platform may test the code by inputting the test input information into the application and executing the code to produce initial test results. The computing platform may store the test input information/initial test results in a table. The computing platform may identify that subsequent testing should be initiated. The computing platform may automatically identify the test input information and the corresponding initial test results using the stored table. The computing platform may automatically test the application by inputting the test input information into the application and executing the application to produce automated test results. The computing platform may compare the automated test results to the initial test results. Based on identifying that the automated test results match the initial test results, the computing platform may deploy the application.

### BACKGROUND

In some instances, applications may be tested through application development life cycle testing, which may require significant effort, time, processing power, and/or other costs. For example, code developers may write test cases to ensure code coverage and may statistically test various code units. However, such test cases may experience issues and/or other bugs in production. Furthermore, such test cases might not be created using real data without the additional efforts and resources needed to write corresponding scripts. Accordingly, application testing may be time consuming, costly, and error prone.

### SUMMARY

Aspects of the disclosure provide effective, efficient, scalable, and convenient technical solutions that address and overcome the technical problems associated with application and code testing. In accordance with one or more embodiments of the disclosure, a computing platform comprising at least one processor, a communication interface, and memory storing computer-readable instructions may receive test input information comprising input information to validate successful performance of code for a software application. The computing platform may test the code by inputting the test input information into the software application and executing the code, wherein testing the code produces initial test results. The computing platform may store the test input information and the initial test results in a table. The computing platform may identify that subsequent testing should be initiated. The computing platform may automatically identify the test input information and the corresponding initial test results using the stored table. The computing platform may automatically test the software application by inputting the test input information into the software application and executing the software application, which may produce automated test results. The computing platform may compare the automated test results to the initial test results. Based on identifying that the automated test results match the initial test results, the computing platform may cause deployment of the software application.

In one or more instances, the test input information may include a username and a password. In one or more instances, the test input information may include input information used to test an overall routine of the software application and one or more subroutines of the software application, where a first portion of the test input information is used to test the overall routine and a second portion of the test input information is used to test the one or more subroutines.

In one or more examples, the second portion of the test input information may be produced through execution of the overall routine. In one or more examples, the test input information may be manually generated.

In one or more instances, the initial test results further comprise one or more error codes corresponding to testing of the code. In one or more instances, automatically testing the software application may include: 1) generating, using generative artificial intelligence and based on the test input information, automated test input information without generating additional code; and 2) automatically testing the software application using the automated test input information.

In one or more examples, based on identifying that the automated test results do not match the initial test results, the computing platform may identify whether a number of errors in the automated test results meets or exceeds a predetermined error threshold. In one or more examples, based on identifying that the number of errors does not meet or exceed the predetermined error threshold, the computing platform may send a notification to a user device indicating that the automated test failed.

In one or more instances, based on identifying that the number of errors meets or exceeds the predetermined error threshold, the computing platform may: 1) send a notification to a user device indicating that the automated test failed and a request for updated test input information, 2) receive the updated test input information, and 3) update the table based on the updated test input information.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using an intelligent code interceptor to generate a no-code automation test suite using generative artificial intelligence (AI) in accordance with one or more example embodiments.

FIGS. 2A-2D depict an illustrative event sequence for using an intelligent code interceptor to generate a no-code automation test suite using generative artificial intelligence (AI) in accordance with one or more example embodiments.

FIG. 3 depicts an illustrative method for using an intelligent code interceptor to generate a no-code automation test suite using generative artificial intelligence (AI) in accordance with one or more example embodiments.

FIGS. 4 and 5 depict illustrative user interfaces for using an intelligent code interceptor to generate a no-code automation test suite using generative artificial intelligence (AI) in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using an intelligent code interceptor to generate a no-code automation test suite using generative artificial intelligence (AI). In application development, life cycle testing is a major phase and may consume a good amount of effort and time. Code developers may write test cases to ensure code coverage and statically test code units. Multiple teams may be involved in setting up test data, writing test plans and scripts for any product/feature testing. The developer and quality assurance (QA) may be involved with different types of testing.

Unit testing refers to testing the unit of code with static data and mocking the downstream dependency. In unit testing, test data may be static and may have predefined confined boundaries. Developers may have to put in extra effort to write or generate unit tests for their code, which may be executed within the build cycle of the code. In today's world, although product builds may claim more than 95% code coverage, unit tests still may reveal particular units of code working in unexpected manners in production, thus resulting in issues and/or bugs. When code is tested with predefined test data with specified boundaries and the downstream flow is mocked, such issues and bugs may be expected.

Automation test scripts or test data may be created and built by QA testers. Currently, there might not be a way to create end to end test suites with real test data without the extra effort of developing a script. Accordingly, described herein is a proposed solution. For example, while a user or business is doing manual functional testing, an automation test suite may be captured. The test may be executed automatically in any environment with a build cycle only without mocking. In doing so, the implementation of a unit test case generator may be avoided, and extra code might not be generated for each testable unit.

More specifically, annotations may be created to demark the code that is to be tested which may capture the entry and exit of testable code. During a development phase, a developer may execute this code. A manual tester or user may test the build from end to end. While testing is underway, the interceptor may intercept the code flow wrapped with annotation, and capture the input and output for the method in a datastore. A generative AI module inside the interceptor may start capturing all the inputs and outputs of each method that is marked to be generated for the automation suite. The generative AI may summarize the datastore by removing duplicate generated test datasets and finalizing the datastore for automated unit testing. Since the solution may be a no-code automation test framework, where no extra code may be needed to execute test cases, a function may loop through all the test data generated by generative AI. This function may call respective service methods from a main code and match the outputs with the generated data store. In a next phase of development, when a build is triggered during the test phase of a build cycle, the method may be intercepted by another wrapper, which may look for entry for the method in the datastore. If the method has information in the datastore, all inputs and corresponding outputs may be fetched and the method may be executed against all inputs. Each execution of the method may be equivalent to the test case of the method and its output may be compared to a stored expected output. This result may be stored as a test result. Once the test phase of the build is completed, code testing may be automatically triggered and executed and the result may be retrieved. These and other features are described in greater detail below.

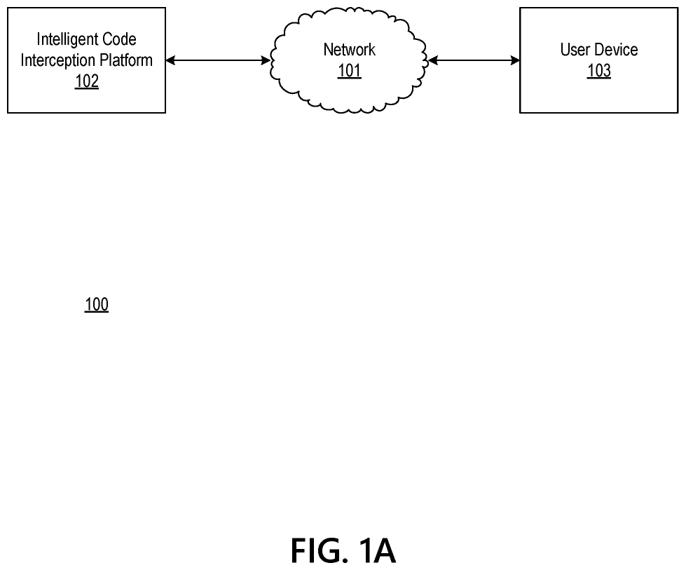

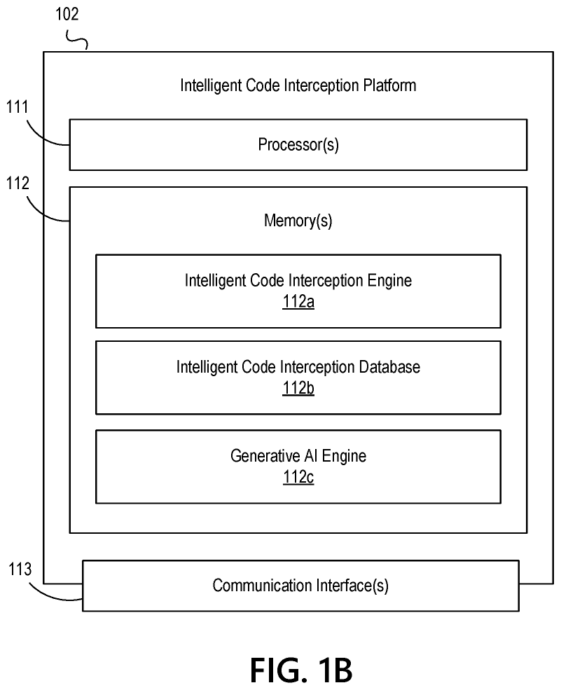

FIGS. 1A-1B depict an illustrative computing environment for using an intelligent code interceptor to generate a no-code automation test suite using generative artificial intelligence (AI) in accordance with one or more example embodiments. Referring to FIG. 1A, computing environment 100 may include one or more computer systems. For example, computing environment 100 may include intelligent code interception platform 102 and user device 103.

Intelligent code interception platform 102 may include one or more computing devices (servers, server blades, or the like) and/or other computer components (e.g., processors, memories, communication interfaces, or the like). For example, the intelligent code interception platform 102 may be configured to train, host, and apply a generative AI model, configured to produce application test cases based on a table of stored application inputs. In some instances, the intelligent code interception platform 102 may also be configured to compare outputs produced by execution of the application test cases to expected outputs stored in the table along with the corresponding application inputs.

User device 103 may be or include one or more devices (e.g., laptop computers, desktop computer, smartphones, tablets, and/or other devices) configured for use in performing application testing (e.g., via communication with the intelligent code interception platform 102). For example, the user device 103 may be used to send test input information that may be used to execute initial tests, the results of which may be stored at the intelligent code interception platform 102 along with the corresponding inputs. In some instances, the user device 103 may be configured to display one or more graphical user interfaces (e.g., validated output interfaces, or the like), which may, e.g., be used to provide feedback on application testing, or the like. Any number of such user devices may be used to implement the techniques described herein without departing from the scope of the disclosure.

Computing environment 100 also may include one or more networks, which may interconnect intelligent code interception platform 102 and user device 103. For example, computing environment 100 may include a network 101 (which may interconnect, e.g., intelligent code interception platform 102 and user device 103).

In one or more arrangements, intelligent code interception platform 102 and user device 103 may be any type of computing device capable of receiving a user interface, receiving input via the user interface, and communicating the received input to one or more other computing devices, and/or training, hosting, executing, and/or otherwise maintaining one or more artificial intelligence models. For example, intelligent code interception platform 102, user device 103, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of intelligent code interception platform 102 and/or user device 103 may, in some instances, be special-purpose computing devices configured to perform specific functions.

Referring to FIG. 1B, intelligent code interception platform 102 may include one or more processors 111, memory 112, and communication interface 113. A data bus may interconnect processor 111, memory 112, and communication interface 113. Communication interface 113 may be a network interface configured to support communication between intelligent code interception platform 102 and one or more networks (e.g., network 101, or the like). Memory 112 may include one or more program modules having instructions that when executed by processor 111 cause intelligent code interception platform 102 to perform one or more functions described herein and/or one or more databases that may store and/or otherwise maintain information which may be used by such program modules and/or processor 111. In some instances, the one or more program modules and/or databases may be stored by and/or maintained in different memory units of intelligent code interception platform 102 and/or by different computing devices that may form and/or otherwise make up intelligent code interception platform 102. For example, memory 112 may have, host, store, and/or include intelligent code interception engine 112a, intelligent code interception database 112b, and generative AI engine 112c. Intelligent code interception engine 112a may have instructions that direct and/or cause intelligent code interception platform 102 to train, host, and/or otherwise execute one or more advanced techniques to intercept application inputs, and generate a table with the inputs and their corresponding output information (which may, e.g., be used for automated application testing by the generative AI engine 112c). Intelligent code interception database 112b may have instructions that direct and/or cause intelligent code interception platform 102 to store information and/or instructions that may be used by the intelligent code interception platform 102 to perform test case simulation and evaluation, and/or perform other functions. Generative AI engine 112c may have instructions that direct and/or cause intelligent code interception platform 102 to train, host, maintain, and/or otherwise apply a generative AI model that may generate and execute application test cases.

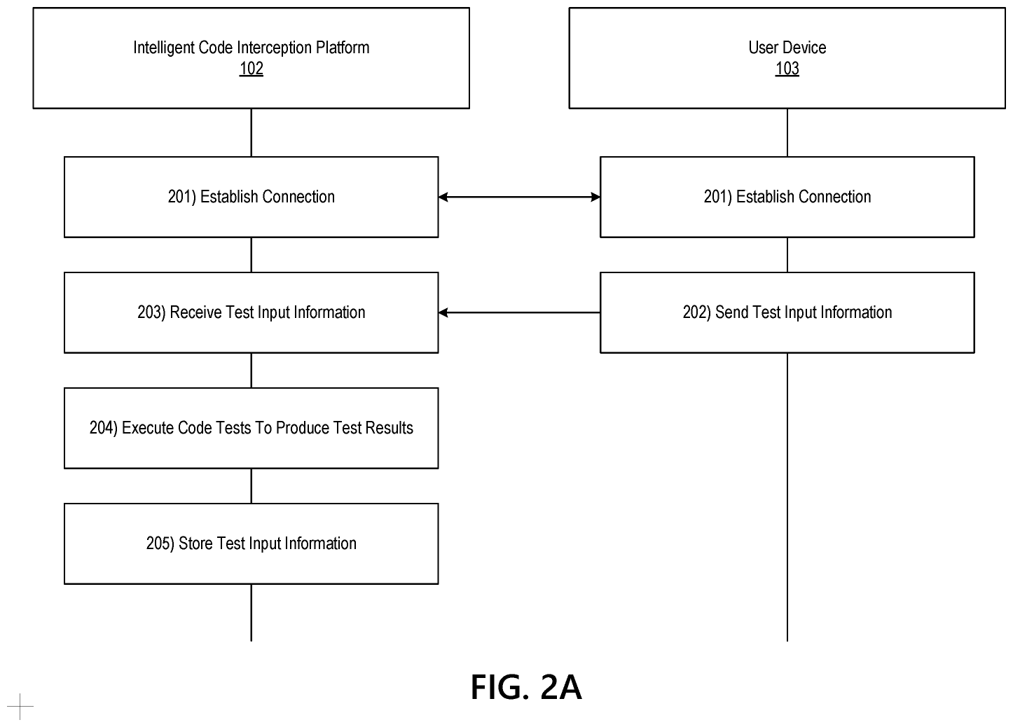

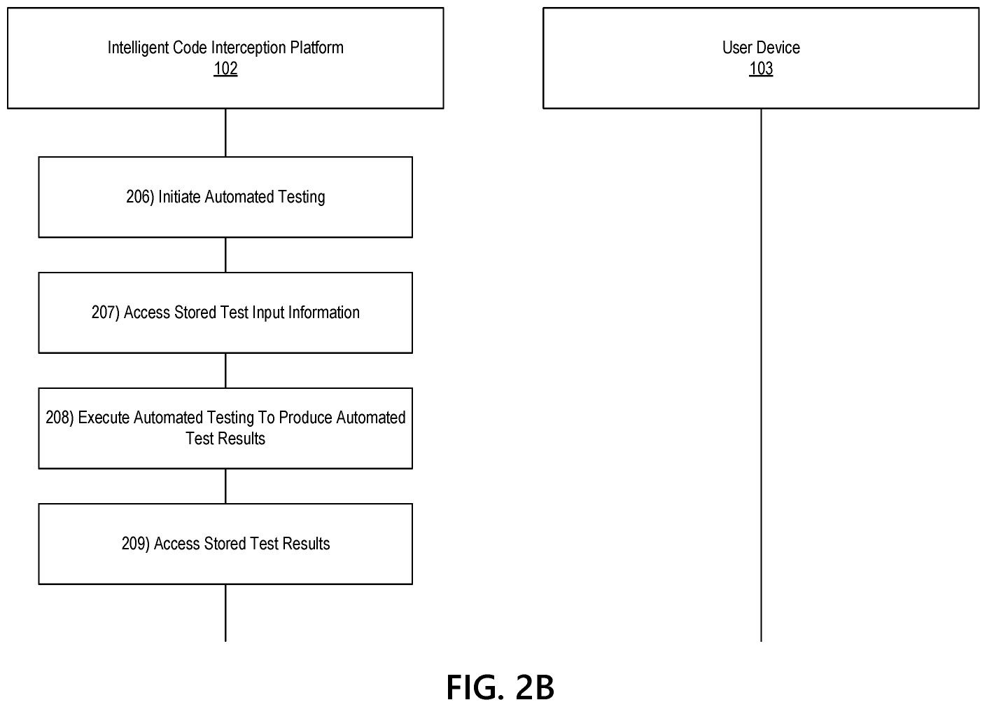

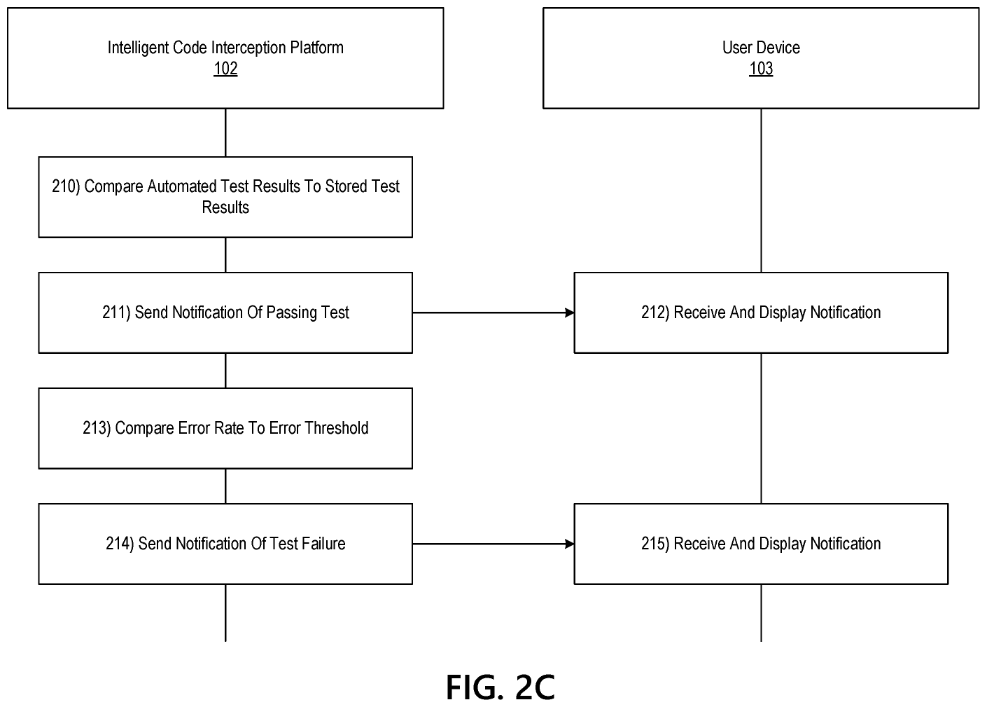

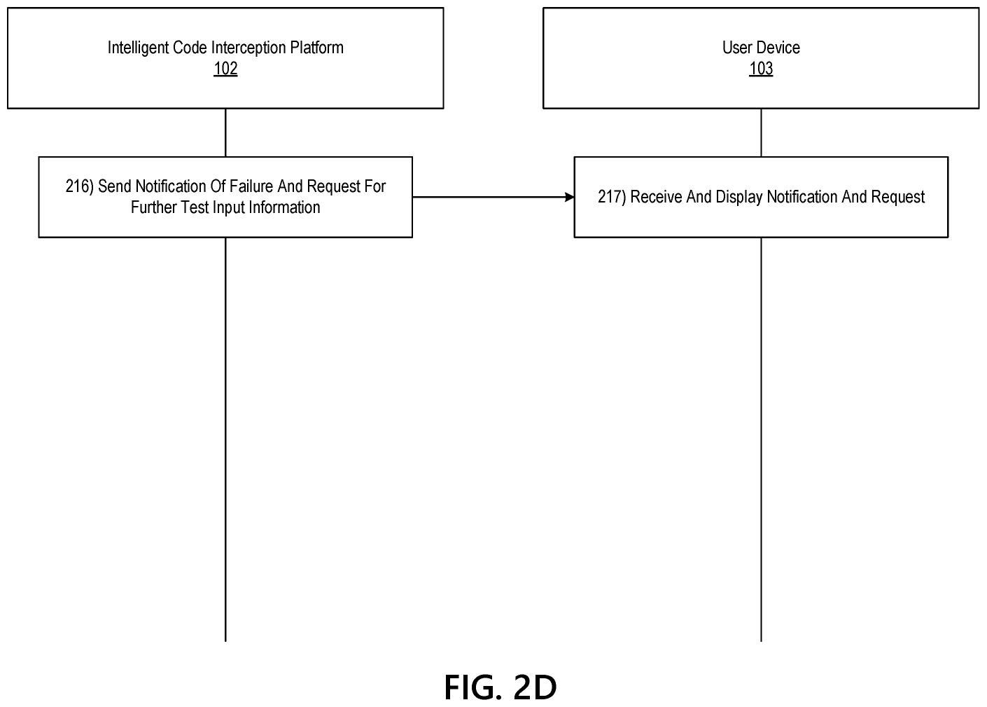

FIGS. 2A-2D depict an illustrative event sequence for using an intelligent code interceptor to generate a no-code automation test suite using generative artificial intelligence (AI) in accordance with one or more example embodiments. Referring to FIG. 2A, at step 201, the user device 103 may establish a connection with the intelligent code interception platform 102. For example, the user device 103 may establish a first wireless data connection with the intelligent code interception platform 102 to link the user device 103 to the intelligent code interception platform 102 (e.g., in preparation for sending test input information). In some instances, the user device 103 may identify whether a connection is already established with the intelligent code interception platform 102. If a connection is already established with the intelligent code interception platform 102, the user device 103 might not re-establish the connection. If a connection is not yet established with the intelligent code interception platform 102, the user device 103 may establish the first wireless data connection as described herein.

At step 202, the user device 103 may send test input information to the intelligent code interception platform 102. For example, the user device 103 may send the test input information while the first wireless data connection is established. In some instances, in sending the test input information, the user device 103 may send information that may be used to initiate one or more processes of a software application, such as a username, password, account information, geo-location information, transaction records, and/or other information. In some instances, this test input information may have been generated at the user device 103 and/or by a user of the user device 103 for the purpose of testing the software application.

At step 203, the intelligent code interception platform 102 may receive the test input information sent at step 202. For example, the intelligent code interception platform 102 may receive the test input information via the communication interface 113 and while the first wireless data connection is established.

At step 204, the intelligent code interception platform 102 may execute code tests to produce test results for the software application. For example, the intelligent code interception platform 102 may input the test input information into the software application to test the corresponding execution. As an example, the intelligent code interception platform 102 may input a combination of a correct username and password, and identify whether or not login is successful (e.g., whether the application successfully causes login). Additionally or alternatively, the intelligent code interception platform 102 may input a combination of a correct username and incorrect password, incorrect username and correct password, and/or incorrect username and incorrect password, and identify whether or not login is successful (e.g., whether the application successfully causes login failure). In these instances, the test results may indicate whether or not the software application correctly responded to the input information (e.g., correctly permitted or blocked login, or the like), error codes, and/or other information.

In some instances, in executing the code tests, an initial routine of the software application may be executed, such as the above described login procedure, and additional information may be identified (e.g., account information, and/or other information). In some instances, in executing the code tests, the intelligent code interception platform 102 may use this identified information as an input for a subroutine of the software application, and may produce test results accordingly. In these instances, one or more subroutines of the software application may similarly be tested. For example, the inputs to the initial (or overall) routine of the software application may be a first portion of the test input information and the inputs used to test the one or more subroutines may be a second portion of the test input information.

At step 205, the intelligent code interception platform 102 may store the test input information and the corresponding test results in a table. In doing so, the intelligent code interception platform 102 may store a correlation between input information and the corresponding results for the software application.

Referring to FIG. 2B, at step 206, the intelligent code interception platform 102 may initiate automated testing of the software application. For example, the intelligent code interception platform 102 may initiate the automated testing in response to detection of expiration of a predetermined time period, more than a predetermined number of changes to the software application, more than a predetermined number of executions of the software application, and/or otherwise.

At step 207, the intelligent code interception platform 102 may access the stored test input information. For example, the intelligent code interception platform 102 may access the test input information stored at step 205.

At step 208, the intelligent code interception platform 102 may execute automated testing of the software application using the test input information accessed at step 207. For example, the intelligent code interception platform 102 may input the test input information into a generative artificial intelligence model that may configure the test input information for input into the software application. For example, the generative AI model may be a large language model corresponding to a chatbot, application program interface (API), website, search engine, or the like. In these instances, the generative AI model may, based on the test input information, generate human-like text, search and retrieve information, summarize text, perform classification, understand natural language and answer questions, analyze sentiment, filter content, translate language, assist with computer code, generate content for creative applications, and/or perform other functions that may result in an appropriate input configured for use in executing the software application.

Additionally or alternatively, the intelligent code interception platform 102 may input the test input information itself. In doing so, the intelligent code interception platform 102 may produce automated test results (which may, e.g., be similar to the test results described above at step 204). In some instances, in executing the automated testing, the intelligent code interception platform 102 might not generate additional code to test the software application.

At step 209, the intelligent code interception platform 102 may access the stored test results (e.g., stored in the table at step 205). For example, the intelligent code interception platform 102 may access the stored results corresponding to the test input information used to initiate the testing at step 208.

Referring to FIG. 2C, at step 210, the intelligent code interception platform 102 may compare the automated test results, generated at step 208, to the initial test results, generated at step 204. If the intelligent code interception platform 102 identifies that the automated test results match the initial test results, the intelligent code interception platform 102 may proceed to step 211. Otherwise, if the automated test results do not match the initial (stored) test results, the intelligent code interception platform 102 may proceed to step 213.

At step 211, the intelligent code interception platform 102 may send a notification of a passing test to the user device 103. For example, the intelligent code interception platform 102 may send the notification via the communication interface 113 and while the first wireless data connection is established. In some instances, the intelligent code interception platform 102 may also send one or more commands directing the user device 103 to display the notification of the passing test. In some instances, in addition to sending the notification of the passing test, the intelligent code interception platform 102 may cause the software application to be deployed.

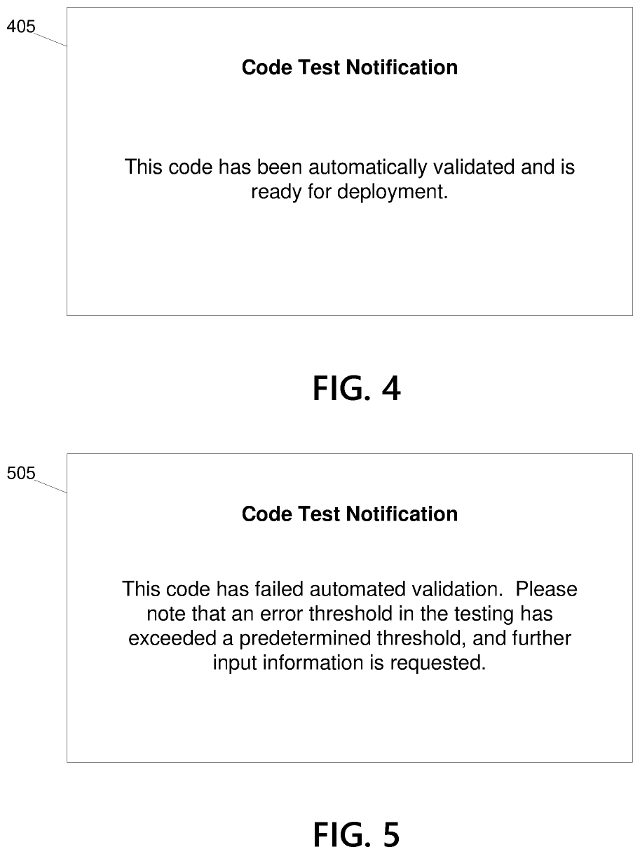

At step 212, the user device 103 may receive the notification of the passing test sent at step 211. In some instances, the user device 103 may receive the notification of the passing test via the communication interface 113 and while the first wireless data connection is established. In some instances, the user device 103 may also receive the one or more commands directing the user device 103 to display the notification. Based on or in response to the one or more commands directing the user device 103 to display the notification, the user device 103 may display the notification of the passing test. For example, the user device 103 may display a notification similar to graphical user interface 405, which is displayed in FIG. 4.

Returning to step 210, if the intelligent code interception platform 102 identified that the automated test results did not match the stored test results, the intelligent code interception platform 102 may have proceeded to step 213. At step 213, the intelligent code interception platform 102 may compare an error rate of the automated test results to a predetermined error threshold. For example, the intelligent code interception platform 102 may identify whether a number of error codes and/or other errors identified in the execution of the automated testing meets or exceeds a predetermined error threshold. If the intelligent code interception platform 102 identifies that the error rate does not meet or exceed the error threshold, the intelligent code interception platform 102 may proceed to step 214. Otherwise, if the error rate does meet or exceed the error threshold, the intelligent code interception platform 102 may proceed to step 216.

At step 214, the intelligent code interception platform 102 may send a notification of the test failure. For example, the intelligent code interception platform 102 may send the notification of the test failure to the user device 103 via the communication interface 113 and while the first wireless data connection is established. In some instances, the intelligent code interception platform 102 may also send one or more commands directing the user device 103 to display the notification of the test failure.

At step 215, the user device 103 may receive the notification of the test failure sent at step 214. For example, the user device 103 may receive the notification of the test failure while the first wireless data connection is established. In some instances, the user device 103 may also receive the one or more commands directing the user device 103 to display the notification of the test failure. Based on or in response to the one or more commands directing the user device 103 to display the notification of the test failure, the user device 103 may display the notification of the test failure.

Returning to step 213, if the intelligent code interception platform 102 identifies that the error rate does meet or exceed the predetermined error threshold, the intelligent code interception platform 102 may have proceeded to step 216. Referring to FIG. 2D, at step 216, the intelligent code interception platform 102 may send a notification of the test failure and a request to input further test input information (e.g., updated and/or otherwise new test input information). For example, the intelligent code interception platform 102 may send the notification of the test failure and the request to input further test input information via the communication interface 113 and while the first wireless data connection is established. In some instances, the intelligent code interception platform 102 may also send one or more commands directing the user device 103 to display the notification of the test failure and the request to input further test input information.

At step 217, the user device 103 may receive the notification of the test failure and the request for further test input information. For example, the user device 103 may receive the notification of the test failure and the request for further test input information via the communication interface 113 and while the first wireless data connection is established. In some instances, the user device 103 may also receive the one or more commands directing the user device 103 to display the notification of the test failure and the request to input further test input information. In these instances, based on the one or more commands directing the user device 103 to display the notification of the test failure and the request to input further test input information, the user device 103 may display the notification of the test failure and the request to input further test input information. For example, the user device 103 may display a graphical user interface similar to graphical user interface 505, which is shown in FIG. 5. The user device 103 may then return to step 202 to provide updated test input information. For example, the test failure may be due do the addition of a new service, a changing application programming interface, or the like.

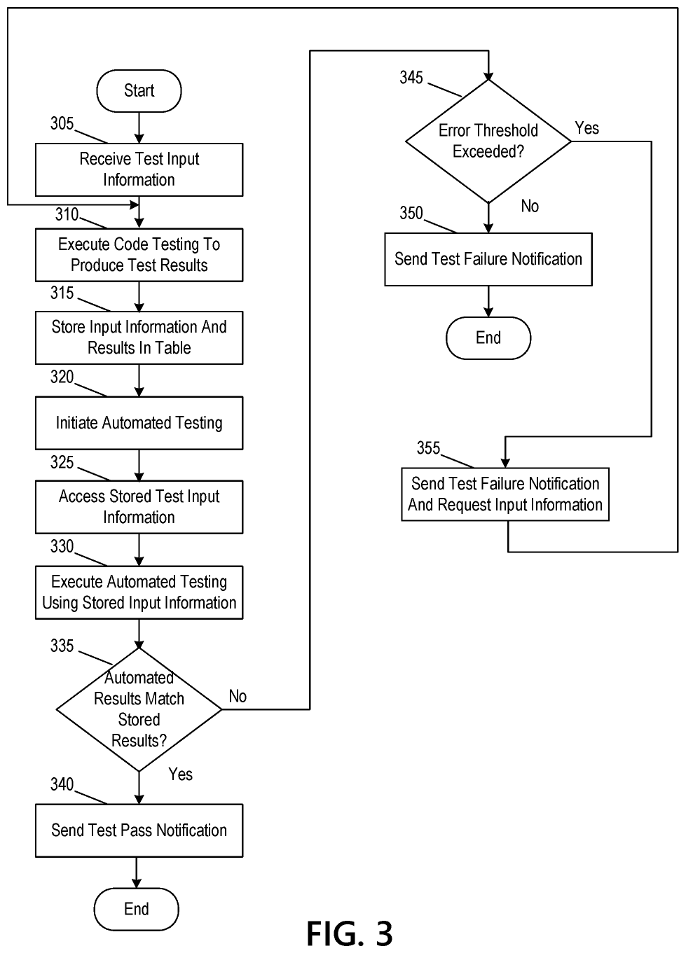

FIG. 3 depicts an illustrative method for using an intelligent code interceptor to generate a no-code automation test suite using generative artificial intelligence (AI) in accordance with one or more example embodiments. Referring to FIG. 3, at step 305, a computing platform comprising one or more processors, memory, and a communication interface may receive test input information. At step 310, the computing platform may execute code testing for a software application to produce test results. At step 315, the computing platform may store the input information and the corresponding test results in a table. At step 320, the computing platform may initiate automated testing of the software application. At step 325, the computing platform may access the stored test input information. At step 330, the computing platform may execute automated testing using the stored input information. At step 335, the computing platform may identify whether or not the automated test results match the stored test results. If the automated test results do match the stored test results, the computing platform may proceed to step 340. At step 340, the computing platform may send a notification of a passing test result to a user device, and the method may end.

Returning to step 335, if the computing platform identifies that the automated test results do not match the stored test results, the computing platform may proceed to step 345. At step 345, the computing platform may identify whether a number or rate of errors meets or exceeds an error threshold. If the error threshold is not met or exceeded, the computing platform may proceed to step 350 to send a notification of a test failure. Otherwise, if the error threshold is met or exceeded, the computing platform may proceed to step 355 to send a notification of the test failure and to request updated input information. The computing platform may then return to step 305 to receive new test input information.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive test input information comprising input information to validate successful performance of code for a software application;
test the code by inputting the test input information into the software application and executing the code, wherein testing the code produces initial test results;
store the test input information and the initial test results in a table;
identify that subsequent testing should be initiated;
automatically identify the test input information and the corresponding initial test results using the stored table;
automatically test the software application by inputting the test input information into the software application and executing the software application, wherein testing the software application produces automated test results;
compare the automated test results to the initial test results; and
based on identifying that the automated test results match the initial test results, cause deployment of the software application.

2. The computing platform of claim 1, wherein the test input information comprises a username and a password.

3. The computing platform of claim 1, wherein the test input information comprises input information used to test an overall routine of the software application and one or more subroutines of the software application, wherein a first portion of the test input information is used to test the overall routine and a second portion of the test input information is used to test the one or more subroutines.

4. The computing platform of claim 3, wherein the second portion of the test input information is produced through execution of the overall routine.

5. The computing platform of claim 1, wherein the test input information is manually generated.

6. The computing platform of claim 1, wherein the initial test results further comprise one or more error codes corresponding to testing of the code.

7. The computing platform of claim 1, wherein automatically testing the software application comprises:
generating, using generative artificial intelligence and based on the test input information, automated test input information, wherein generating the automated test input information avoids generation of additional code; and
automatically testing the software application using the automated test input information.

8. The computing platform of claim 1, wherein the memory stores additional computer readable instructions that, when executed by the at least one processor, cause the computing platform to:
based on identifying that the automated test results do not match the initial test results, identify whether a number of errors in the automated test results meets or exceeds a predetermined error threshold.

9. The computing platform of claim 8, wherein the memory stores additional computer readable instructions that, when executed by the at least one processor, cause the computing platform to:
based on identifying that the number of errors does not meet or exceed the predetermined error threshold, sending a notification to a user device indicating that the automated test failed.

10. The computing platform of claim 8, wherein the memory stores additional computer readable instructions that, when executed by the at least one processor, cause the computing platform to:
based on identifying that the number of errors meets or exceeds the predetermined error threshold:
sending a notification to a user device indicating that the automated test failed and a request for updated test input information,
receiving the updated test input information, and
updating the table based on the updated test input information.

11. A method comprising:
at a computing platform comprising at least one processor, a communication interface, and memory:
receiving test input information comprising input information to validate successful performance of code for a software application;
testing the code by inputting the test input information into the software application and executing the code, wherein testing the code produces initial test results;
storing the test input information and the initial test results in a table;
identifying that subsequent testing should be initiated;
automatically identifying the test input information and the corresponding initial test results using the stored table;
automatically testing the software application by inputting the test input information into the software application and executing the software application, wherein testing the software application produces automated test results;
comparing the automated test results to the initial test results; and
based on identifying that the automated test results match the initial test results, causing deployment of the software application.

12. The method of claim 11, wherein the test input information comprises a username and a password.

13. The method of claim 11, wherein the test input information comprises input information used to test an overall routine of the software application and one or more subroutines of the software application, wherein a first portion of the test input information is used to test the overall routine and a second portion of the test input information is used to test the one or more subroutines.

14. The method of claim 13, wherein the second portion of the test input information is produced through execution of the overall routine.

15. The method of claim 11, wherein the test input information is manually generated.

16. The method of claim 11, wherein the initial test results further comprise one or more error codes corresponding to testing of the code.

17. The method of claim 11, wherein automatically testing the software application comprises:
generating, using generative artificial intelligence and based on the test input information, automated test input information, wherein generating the automated test input information avoids generation of additional code; and
automatically testing the software application using the automated test input information.

18. The method of claim 11, further comprising:
based on identifying that the automated test results do not match the initial test results, identifying whether a number of errors in the automated test results meets or exceeds a predetermined error threshold.

19. The method of claim 18, further comprising:
based on identifying that the number of errors does not meet or exceed the predetermined error threshold, sending a notification to a user device indicating that the automated test failed.

20. One or more non-transitory computer-readable media storing instructions that, when executed by a computing platform comprising at least one processor, a communication interface, and memory, cause the computing platform to:
receive test input information comprising input information to validate successful performance of code for a software application;
test the code by inputting the test input information into the software application and executing the code, wherein testing the code produces initial test results;
store the test input information and the initial test results in a table;
identify that subsequent testing should be initiated;
automatically identify the test input information and the corresponding initial test results using the stored table;
automatically test the software application by inputting the test input information into the software application and executing the software application, wherein testing the software application produces automated test results;
compare the automated test results to the initial test results; and
based on identifying that the automated test results match the initial test results, cause deployment of the software application.
